(19) United States
(12) Patent Application Publication
(10) Pub. No.: US 2013/0133480 A1
(43) Pub. Date: May 30, 2013

(54) HYBRID DRIVE TRAIN FOR A GAS TURBINE ENGINE

(71) Applicant: ICR Turbine Engine Corporation, Hampton, NH (US)

(72) Inventor: Frank Wegner Donnelly, North Vancouver (CA)

(73) Assignee: ICR TURBINE ENGINE CORPORATION, Hampton, NH (US)

(21) Appl. No.: 13/687,766

(22) Filed: Nov. 28, 2012

Related U.S. Application Data
(60) Provisional application No. 61/564,018, filed on Nov. 28, 2011.
(60) Provisional application No. 61/603,063, filed on Feb. 24, 2012.

(51) Int. Cl. B60K 6/36; B60W 10/02

(52) U.S. Cl. CPC B60K 6/36; B60W 10/02; Y10S 903/946
USPC 74/720; 180/65.21; 903/946

(57) ABSTRACT

Several configurations of a hybrid drive train are disclosed using a one-way clutch to prevent reverse power flow from the drive train to a free power turbine. The drive trains are parallel configurations including a generator/motor that can provide a dynamic or regenerative braking capability or a power boost if required. The drive train can be based on a manual or automatic transmission. A dry clutch can be used to engage and disengage the engine from the transmission. A generator/motor can be used to neutralize torque for disengaging the gearing in a transmission or to synchronize the rotational speeds of the gearing for engaging the gearing in a transmission, thus eliminating the need for a dry clutch when a manual transmission is used.

### CROSS REFERENCE TO RELATED APPLICATION

The present application claims the benefits, under 35 U.S.C.§119(e), of U.S. Provisional Application Ser. No. 61/564,018 entitled “Hybrid Transmission for a Gas Turbine Engine” filed Nov. 28, 2011 and Provisional Application Ser. No. 61/603,063 entitled “Hybrid Transmission for a Gas Turbine Engine” filed Feb. 24, 2012, both of which are incorporated herein by reference.

### FIELD

The present disclosure relates generally to a hybrid drive train suitable for vehicles utilizing gas turbine engines.

### BACKGROUND

There is a growing requirement for alternate fuels for vehicle propulsion and power generation. These include fuels such as natural gas, bio-diesel, ethanol, methanol, butanol, hydrogen and the like. Means of utilizing fuels more efficiently and with substantially lower carbon dioxide emissions and other air pollutants such as NOxs are required.

The gas turbine or Brayton cycle power plant has demonstrated many attractive features which make it a candidate for advanced vehicular propulsion as well as power generation. Gas turbine engines have the advantage of being highly fuel flexible and fuel tolerant. Additionally, these engines burn fuel at a lower temperature than comparable reciprocating engines so produce substantially less NOx per mass of fuel burned.

A multi-spool intercooled, recuperated gas turbine system is particularly suited for use as a power plant for a vehicle, especially a truck, bus or other overland vehicle. However, it has broader applications and may be used in many different environments and applications, including as a stationary electric power module for distributed power generation. The efficiency of such a gas turbine engine can be improved and engine size can be further reduced by increasing the pressure and/or temperature developed in the combustor while still remaining well below the temperature threshold of significant NOx production. This can be done using conventional a metallic combustor or a thermal reactor to extract energy from the fuel.

A multi-spool intercooled, recuperated gas turbine engine that meets these requirements is described in U.S. patent application Ser. No. 12/115,134 filed May 5, 2008, entitled “Multi-Spool Intercooled Recuperated Gas Turbine” which is incorporated herein by reference.

Further gains in efficiency can be realized by adding additional intercooling and reheater apparatuses such as described in U.S. patent application Ser. No. 13/534,909 filed Jun. 27, 2012, entitled “High Efficiency Compact Gas Turbine Engine” which is incorporated herein by reference.

In order to realize the efficiency, emissions and performance advantages of such engines, a suitable drive train is required since the power output of these engines is typically from a free power turbine which has quite different torque versus speed characteristics than those of a reciprocating engine. It is usually desirable to prevent reverse power flow from the drive train to the free power turbine, especially during down-shifting to prevent over-speeding the free power turbine rotor.

A parallel hybrid drive train typically operates at low speeds as an electrical drive train. This tends to be significantly less efficient than a drive train incorporating a manual transmission. A manual transmission is typically about 95% to about 98% efficient. An electrical transmission is typically about 85% to about 92% efficient. When operating in electric mode, it is more efficient to decouple the free power turbine from the drive train to eliminate the parasitic load of the free power turbine.

Therefore, there remains a need for suitable drive train configurations that can match gas turbine engine characteristics with expectations for driving a conventional vehicle. Further, there is a need for such drive trains to be capable of managing energy recovered by dynamic or regenerative braking systems at all speeds while preventing reverse power flow from the drive train to the free power turbine and eliminating parasitic loads.

### SUMMARY

These and other needs are addressed by the various embodiments and configurations of the present disclosure which are directed generally to a hybrid drive train suitable for vehicles utilizing gas turbine engines and specifically to a gas turbine engine that delivers power to a drive train by a free power turbine.

The hybrid drive train configurations of the present disclosure all utilize a one-way clutch to prevent reverse power flow from the drive train to a free power turbine. This prevents over-speeding the free power turbine when, for example, downshifting at high speed. The hybrid drive train configurations are illustrated by an intercooled recuperated multi-spool gas turbine engine suitable for vehicle propulsion. Another advantage of a one-way clutch is that it allows the vehicle to run in electric propulsion mode without having to give up power spinning the free power turbine. Further, the drive train of the present disclosure is a parallel configuration which includes a generator/motor that can provide a regenerative braking capability or a power boost if required.

In a first configuration, the drive train is based on a manual transmission wherein a dry clutch is used to engage and disengage the engine from the transmission.

In a second configuration, the drive train is based on an automatic transmission wherein the automatic transmission engages and disengages the engine from the drive shaft.

In a third configuration, a generator/motor is part of the drive train and is used to neutralize torque for disengaging the gears on a manual transmission or to synchronize the rotational speed of the gearing for engaging. In other words, the generator/motor can be operated to eliminate the need for a dry clutch when a manual transmission is used.

In one embodiment, a vehicle is disclosed comprising:

1) a gas turbine engine as a prime power source; and

2) a drive train operatively connected to the gas turbine engine to propel the vehicle, wherein the drive train is free of a dry clutch and comprises: i) a one-way clutch to inhibit reverse power flow from the drive train to the engine; ii) a manual transmission comprising a gear set with a first and second gear having a gear ratio between the first gear and the second gear; and iii) a generator/motor to at least one of: absorb sufficient power to substantially neutralize torque of the drive train to enable disengaging the transmission from a drive shaft of the drive train; and absorb or supply sufficient power to substantially synchronize the first and second gears in the gear set to enable engaging the transmission with the drive shaft of the drive train.

In another embodiment, a method is disclosed comprising:

1) operating a gas turbine engine as a prime power source to power a drive train operatively connected to the gas turbine engine and thereby propel a vehicle wherein the drive train is free of a dry clutch and comprises a generator/motor and a manual transmission comprising a gear set with a first and second gear having a gear ratio between the first gear and the second gear;

2) inhibiting, by a one-way clutch, reverse power flow from the drive train to the gas turbine engine; and

3) performing at least one of the following sub-steps:
(a) absorbing, by the generator/motor, sufficient power to overcome and/or substantially neutralize torque of the drive train to enable disengaging the transmission from a drive shaft of the drive train; and
(b) absorbing or supplying, by the generator/motor, sufficient power to substantially synchronize the first and second gears in the gear set in the drive train to enable engaging the transmission with the drive shaft of the drive train.

In another embodiment, a drive train is disclosed comprising:

1) a first output shaft operatively engaged with a free power turbine of a gas turbine engine;

2) a gearbox operatively engaged with the first output shaft; 3) a second output shaft operatively engaged with a transmission;

4) a one-way clutch positioned between the gearbox and the second output shaft to inhibit reverse power flow from the second output shaft to the gas turbine engine;

5) a manual transmission comprising a gear set with a first and second gear having a gear ratio between the first gear and the second gear; and

6) a generator/motor to at least one of: absorb sufficient power to substantially neutralize torque of the drive train to enable disengaging the transmission from a drive shaft of the drive train; and absorb or supply sufficient power to substantially synchronize the first and second gears in the gear set to enable engaging the transmission with the drive shaft of the drive train.

In yet another embodiment, a vehicle is disclosed comprising:

1) a gas turbine engine as a prime power source wherein the gas turbine engine comprises a lower pressure compressor coupled to a lower pressure turbine, a higher pressure compressor coupled to a higher pressure turbine, an intercooler positioned in a fluid path between the lower and higher pressure compressors, a recuperator to transfer heat from an exhaust gas to a compressed fluid, a combustor to combust the compressed fluid, and a free power turbine providing power from the gas turbine engine to the drive train;

2) a drive train operatively connected to the gas turbine engine to propel the vehicle, wherein the drive train is free of a dry clutch and comprises a one-way clutch to inhibit reverse power flow from the drive train to the engine;

3) an automatic or manual transmission; and

4) a generator/motor to at least one of: (i) absorb sufficient power to substantially neutralize torque of the drive train to enable disengaging the transmission from a drive shaft of the drive train and (ii) absorb or supply sufficient power to substantially synchronize the first and second gears in the gear set to enable engaging the transmission with the drive shaft of the drive train.

The embodiment includes a method and drive train for the vehicle.

The above-described embodiments and configurations are neither complete nor exhaustive. As will be appreciated, other embodiments of the disclosure are possible utilizing, alone or in combination, one or more of the features set forth above or described in detail below.

As noted above, the hybrid drive train configurations all utilize a one-way clutch to prevent reverse power flow from the drive train to a free power turbine.

These and other advantages will be apparent from the disclosures contained herein.

The following definitions are used herein:

The phrases at least one, one or more, and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

A bell housing is a term for the portion of the transmission that covers the flywheel and the clutch or torque converter of the transmission on vehicles powered by internal combustion engines. This housing is bolted to the engine block and derives its name from the bell-like shape that its internal components necessitate. The starter motor is usually mounted here, and engages with a ring gear on the flywheel. On the opposite end to the engine is usually bolted to the gearbox. The above is the normal arrangement for an in-line transmission system for a conventional rear wheel drive or all wheel drive vehicle. The arrangement for a transverse mounted engine and transmission for a front wheel drive vehicle has the gear box and differential below the engine and consequently the bell housing is a simple cover for the flywheel.

A bull gear is the larger of two gears that are in engagement. The smaller gear is usually referred to as a pinion gear.

As used herein, a clutch is a device used to connect or disconnect flow of power from one part of a transmission from another. For example, in a typical reciprocating engine vehicle, the clutch is the mechanism in the drive train that connects the engine crankshaft to or disconnects it from the gearbox thus with the remainder of the drive train.

Computer-readable medium as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A Continuously Variable Transmission or CVT has a low gear ratio and a high gear ratio with infinitely many ratios in-between. The advantage of a CVT is the ability to keep the engine's RPMs in their optimum power output range for all operating conditions. A vehicle with a CVT transmission can be readily diagnosed with software. Unlike traditional automatic transmissions, continuously variable transmissions don't have a gearbox with a set number of gears, which means they don't have interlocking toothed wheels. The most common type of CVT operates on a pulley system that allows an infinite variability between highest and lowest gears with no discrete steps or shifts. Other types of CVTs include toroidal and hydrostatic.

Determine, calculate and compute and variations thereof, as used herein, are used interchangeably and include any type of methodology, process, mathematical operation or technique.

A differential connects a drive shaft to axles. While the differential may provide gear reduction, its primary purpose is to change the direction of rotation.

A drive train is the part of a vehicle or power generating machine that transmits power from the engine to the driven members, such as the wheels on a vehicle, by means of any combination of belts, fluids, gears, flywheels, electric motors, clutches, torque converters, shafts, differentials, axles and the like.

An energy storage system refers to any apparatus that acquires, stores and distributes mechanical or electrical energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

An engine braking device as used herein is an auxiliary braking apparatus that dissipates engine power when engaged. When engaged, the engine braking device may dissipate power from the engine when the transmission clutch is not engaged and may increase vehicle braking force when the transmission clutch is engaged.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

The foundation braking system of a vehicle, as used herein, comprise the drum and/or disc brakes associated with all or most of the wheels of a vehicle.

A gear box as used herein is a housing that includes at least one gear set. Typically, a gear box on a vehicle includes switchable gear sets to provide multiple gear ratios, with the ability to switch between them as speed varies. Directional (forward and reverse) control may also be provided. This switching may be done manually or automatically.

A gear set as used herein is a single ratio gear assembly.

Jake brake or Jacobs brake describes a particular brand of engine braking system. It is used generically to refer to engine brakes or compression release engine brakes in general, especially on large vehicles or heavy equipment. An engine brake is a braking system used primarily on semi-trucks or other large vehicles that modifies engine valve operation to use engine compression to slow the vehicle. They are also known as compression release engine brakes.

A manual transmission, also known as a manual gearbox or standard transmission is a type of transmission used in motor vehicle applications. It uses a driver-operated clutch for regulating torque transfer from the engine to the transmission. A manual transmission can be replaced by an automated transmission such as an automatic transmission, a semi-automatic transmission, or a continuously variable transmission (CVT). Automatic transmissions that allow the driver to manually select the current gear are called manumatics. A manual-style transmission operated by computer is often called an automated transmission rather than an automatic. Some transmissions, called sequential transmissions, do not allow the driver to arbitrarily select any gear but may only select the next-lowest or next-highest gear ratio. Modern manual transmissions are commonly fitted with a synchronized gear box. In a synchromesh transmission, transmission gears are always in mesh and rotating, but gears on one shaft can freely rotate or be locked to the shaft. Heavy-duty transmissions are almost always non-synchromesh, one reason being that a synchromesh transmission adds weight. Heavy-duty trucks that need to be shifted very often may use automatic transmissions despite their increased weight, cost, and loss of efficiency.

A mechanical diode is a type of one-way clutch mechanism. A mechanical diode is typically a ratchet type of one-way clutch. A mechanical diode has the advantage of low-mass and a high ratio of contact area to mass which allows a relatively small spring to very rapidly move the struts into locking position.

A mechanical-to-electrical energy conversion device refers an apparatus that converts mechanical energy to electrical energy or electrical energy to mechanical energy. Examples include but are not limited to a synchronous alternator such as a wound rotor alternator or a permanent magnet machine, an asynchronous alternator such as an induction alternator, a DC generator, and a switched reluctance generator. A traction motor is a mechanical-to-electrical energy conversion device used primarily for propulsion.

A one-way clutch is a clutch that is engaged for mechanical power flow in a selected direction along a drive train. Typically, a one-way clutch automatically disengages when power flow is reversed. Examples of one-way clutches include a sprag clutch, a ratchet clutch, a roller ramp clutch and a mechanical diode.

Over-speed control of a free power turbine means control of the rpms of a free power turbine by preventing the rpms from increasing beyond a selected value. Typically, a free power turbine will over-speed if the gas driving the turbine remains on while the load (transmission or electrical generator for example) is rapidly or abruptly turned off. A free power turbine will also over-speed if the transmission of a drive train is downshifted into a lower gear at too high a speed.

A parallel hybrid drive train is powered either by an engine or an electric motor or both.

A pinion is the smaller of two gears that are in engagement. The larger gear is usually referred to as a bull gear.

A planetary gear (also known as an epicyclic gear) is a gear system consisting of one or more outer gears, or planet gears, revolving about a central, or sun gear (also known as a sun pinion). Typically, the planet gears are mounted on a planet carrier plate which itself may rotate relative to the sun gear. Planetary gearing systems also incorporate the use of an outer ring gear or orbit gear which meshes with the planet gears. In this gear system, the sun gear engages all planet gears simultaneously. All are attached to a planet carrier plate, and they engage the inside of the ring gear. The output shaft may be attached to the ring gear, and the planet carrier may be held stationary. Alternately the output shaft may be attached to the planet carrier and the ring gear may be held stationary. Planetary gear sets can produce different gear ratios depending on which gear is used as the input, which gear is used as the output and which gear is held stationary. For instance, if the input is the sun gear the ring gear is held stationary and the output shaft is attached to the planet carrier, a particular gear ratio is obtained.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator is a heat exchanger that transfers heat through a network of tubes, a network of ducts or walls of a matrix wherein the flow on the hot side of the heat exchanger is typically exhaust gas and the flow on cold side of the heat exchanger is typically gas (for example, air or a fuel-air mixture) entering the combustion chamber.

Regenerative braking is the same as dynamic braking except the electrical energy generated is recaptured and stored in an energy storage system for future use.

RPMs or rpms mean revolutions per minute.

Specific power as used herein is power per unit mass (watts per kilogram).

A series hybrid drive train is typically comprised of electric traction motors powered by a battery or other energy storage device. An engine is used to recharge the battery or other energy storage device so the engine does not directly power the drive train.

Spool means a group of turbo machinery components on a common shaft.

A sprag clutch is a one-way freewheel clutch. It resembles a roller bearing, but instead of cylindrical rollers, non-revolving asymmetric figure-of-eight shaped sprags are used. When the unit rotates in one direction the rollers slip or free-wheel, but when a torque is applied in the opposite direction, the rollers tilt slightly, producing a wedging action and binding because of friction. The sprags are spring-loaded so that they lock. A sprag clutch is used in some automatic transmissions as a method of allowing the transmission to smoothly change gears under load. A sprag clutch is also used in many helicopter designs to transfer power from the engine to the main rotor. In the event of an engine failure, the sprag clutch allows the main rotor to continue rotating faster than the engines so that the helicopter can enter autorotation.

In a synchromesh manual-transmission, transmission gears are always in mesh and rotating, but gears on one shaft can freely rotate or be locked to the shaft. The locking mechanism for a gear consists of a collar on the shaft which is able to slide sideways so that teeth on its inner surface bridge two circular rings with teeth on their outer circumference. One is attached to the gear and one to the shaft. When the rings are bridged by the collar, that particular gear is rotationally locked to the shaft and determines the output speed of the transmission. The gearshift mechanism manipulates the collars using a set of linkages, so arranged so that one collar may be permitted to lock only one gear at any one time. When shifting gears, the locking collar from one gear is disengaged before that of another is engaged. In a prior art synchromesh transmission, to correctly match the speed of the gear to that of the shaft as the gear is engaged the collar initially applies a force to a cone-shaped brass clutch attached to the gear, which brings the speeds to match prior to the collar locking into place. The collar is prevented from bridging the locking rings when the speeds are mismatched by synchro rings. The synchro ring rotates slightly due to the frictional torque from the cone clutch. In this position, the clutch is prevented from engaging. The brass clutch ring gradually causes parts to spin at the same speed. When they do spin the same speed, there is no more torque from the cone clutch and the clutch is allowed to fall in to engagement.

Synchronizing gears means setting the rpms of the gearing so that so that the gearing can be smoothly engaged. This can be done with a synchromesh mechanism or can be accomplished with a non-synchromesh transmission under computer control of rpms and torque.

A thermal energy storage module is a device that includes either a metallic heat storage element or a ceramic heat storage element with embedded electrically conductive wires. A thermal energy storage module is similar to a heat storage block but is typically smaller in size and energy storage capacity.

As used herein, a transmission is the part of a vehicle or power generating machine that transmits power from the output shaft of an engine to a drive shaft by means of any combination of belts, fluids, gears, flywheels, electric generators, clutches, torque converters and the like. A transmission may be a manual transmission or an automatic transmission. A transmission may be an all-mechanical apparatus or an apparatus with both mechanical and electrical components. The latter may also be called a hybrid transmission. In British usage, the term transmission typically refers to the whole drive train, including gearbox, clutch, drive shaft, differential and axles. In American usage for reciprocating engines, the transmission is often taken to be the gearbox between the clutch assembly in the bell housing and the drive shaft. The more general definition is used herein (power transmission apparatuses from the output shaft of an engine to a drive shaft) unless specifically defined otherwise.

A turbine is any machine in which mechanical work is extracted from a moving fluid by expanding the fluid from a higher pressure to a lower pressure.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

A wastegate is a valve that diverts exhaust gases away from the turbine wheel in a turbocharged engine system. Diversion of exhaust gases helps regulate the turbine speed, which in turn regulates the rotating speed of the compressor in a turbo-compressor spool.

As used herein, positive torque in a drive train refers to power flowing from an engine to the wheels of a vehicle. Likewise, negative torque in a drive train refers to power flowing the wheels of a vehicle to the engine.

As used herein, engaging gears refers to engaging the actual gears in a non-synchromesh manual transmission and engaging the gears with their respective shafts in a synchromesh manual transmission.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is a schematic of a first configuration of a hybrid drive train.

FIG. 2 is a schematic of a second configuration of a hybrid drive train.

FIGS. 3a-c show several types of prior art one-way clutch mechanisms.

FIG. 4 is a schematic of a simplified controller input/output diagram.

FIG. 5 is an example of a braking system based on the drive trains of FIG. 1 or 2.

FIG. 6 is a schematic of a third configuration of a hybrid drive train.

FIG. 7 is an example of a braking system based on the drive trains of FIG. 6.

FIG. 8 shows an example of a system for measuring shaft torque and rpms.

FIGS. 9a-b are flow charts for automatically shifting gears in a manual transmission using a generator/motor to eliminate the need for a dry clutch.

### DETAILED DESCRIPTION

The drive trains of the present disclosure are unique because of their use of a one-way clutch to prevent reverse torque being applied to the free power turbine which produces the shaft power from a gas turbine engine suitable for vehicles such as cars, trucks, buses, marine craft and locomotives. Reverse torque situations can occur for example, when the engine is throttled down and the vehicle is braking or when downshifting at high speed.

The drive trains of the present disclosure are illustrated by an intercooled, recuperated multi-spool gas turbine engine such as previously disclosed in U.S. patent application Ser. No. 12/115,134 entitled “Multi-Spool Intercooled Recuperated Gas Turbine” and in U.S. patent application Ser. No. 13/534,909 entitled “High Efficiency Compact Gas Turbine Engine”. The gas turbine engine used for illustration is a 370 kW engine comprised of two turbo-compressor spools and a free power turbine where mechanical shaft power is provided by the free power turbine. As is well-known output shaft torque is equal to output shaft power divided by shaft rotational speed using a consistent set of units.

τ=9,540 P/rpm

where P=power in kW;

rpm=revolutions per minute, and;

τ=torque in N-m

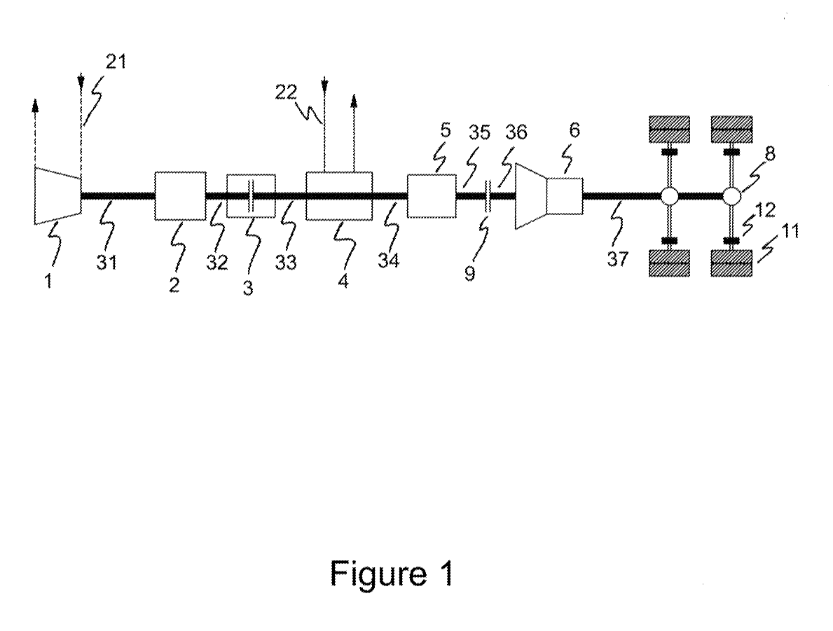

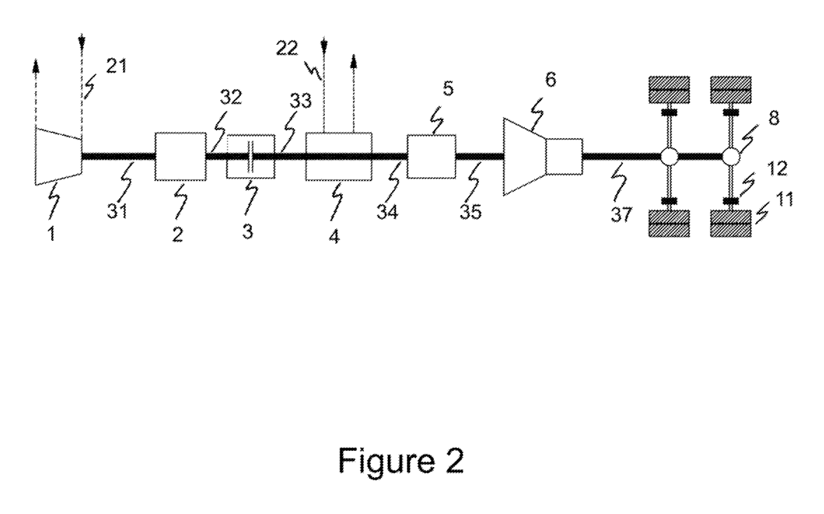

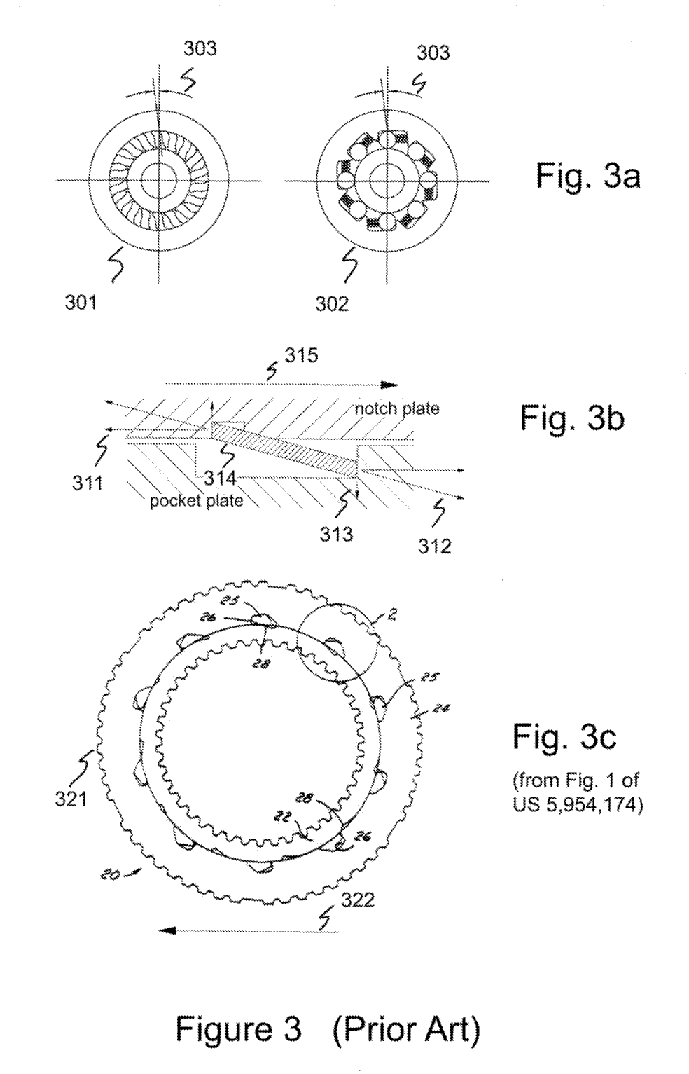

FIG. 1 is a schematic of a first configuration of a hybrid drive train. FIG. 1 shows a free power turbine 1 which is driven by gas flowing in via gas path 21 and expanding to drive the turbine and then flowing out. Free power turbine 1 has a shaft output 31 that rotates, for example, in the range of about 50,000 to about 100,000 rpms for a gas turbine engine that outputs about 370 kW of power at full power. The output rpms of free power turbine 1 are reduced by gearbox 2 by a gear ratio of about 6.75:1. The output of gearbox 2, via shaft 32, then drives one-way clutch 3 which is locked when positive torque is being applied to the drive train by free power turbine 1. Output shaft 33 then goes through generator/motor 4 which is free-wheeling unless excitation is applied to the generator/motor 4. Electrical energy generation or extraction by generator/motor 4 is via electrical path 22. In this configuration, the output shaft 34 from generator/motor 4 then goes to a planetary (or parallel) gear set 5 which further reduces the rpms by a gear ratio of about 5:1. The output shaft 35 of gear set 5 then goes to dry clutch 9 and then via shaft 36 to manual transmission 6. Transmission 6 typically has gearing in the range of about 0.65:1 (highest gear) to about 5:1 (lowest gear). Transmission 6 powers drive shaft 7 which is attached to one or more differentials 8. The differentials typically reduce drive shaft 7 rpms by a ratio of about 4:1.

The typical reduction between the outputs of free power turbine 1 and gearbox 2 is commonly in the range of about 3:1 to about 8:1 and more commonly in the range of about 4:1 to about 7:1. The typical reduction between the outputs of the output generator/motor 4 and planetary (or parallel) gear set 5 is commonly in the range of about 6:1 to about 2:1 and more commonly in the range of about 5:1 to about 3:1. The typical reduction through transmission 6 is commonly in the range of about 6:1 to about 0.5:1 and more commonly in the range of about 5:1 to about 0.65:1. The typical reduction through differentials 8 is commonly in the range of about 5:1 to about 1:1 and more commonly in the range of about 4.5:1 to about 2:1.

The following tables illustrate an example of the reduction of rpms through the drive train of FIG. 1 with a dry clutch and manual transmission. The free power turbine in this illustration is suitable for about a 300 to 450 kW maximum power output gas turbine engine and has a free power turbine output shaft rpm in the range of about 50,000 to about 100,000.

TABLE I

| | Gear Ratio | Output Shaft rpms |
|---|---|---|
| Free Power Turbine | | 60,000 |
| First Reducing Gear Set | 6.78:1 | 8,850 |
| Planetary or Parallel Gear Set | 4.7:1 | 1,883 |
| Transmission 6th Gear | 0.67:1 | 2,810 |
| Differential | 4.33:1 | 650 |
| Vehicle Speed (40-in dia tires) | | 77 mph |

TABLE II

| | Gear Ratio | Output Shaft rpms |
|---|---|---|
| Free Power Turbine | | 60,000 |
| First Reducing Gear Set | 6.78:1 | 8,850 |
| Planetary or Parallel Gear Set | 4.7:1 | 1,883 |
| Transmission 1st Gear | 4.7:1 | 400 |
| Differential | 4.33:1 | 93 |
| Vehicle Speed (40-in dia tires) | | 11 mph |

The following tables illustrate an example of the increase of torque through the drive train of FIG. 1. The free power turbine is suitable for about a 300 to 450 kW power output gas turbine engine and has an output shaft rpm in the range of about 50,000 to about 100,000. The free power turbine outputs in the following example are 200 kW and 60,000 rpms in 6^{th} gear and 360 kW at 60,000 rpms in 1^{st} gear.

TABLE III

| | | Output Shaft Torque |
|---|---|---|
| | Gear Ratio | (N-m) |
| Free Power Turbine | | 31.8 |
| First Reducing Gear Set | 6.78:1 | 214 |
| Planetary or Parallel Gear Set | 4.7:1 | 990 |
| Transmission 6th Gear | 0.67:1 | 650 |
| Differential | 4.33:1 | 2,784 |
| Vehicle Speed (40-in dia tires) | | 77 mph |

TABLE IV

| | | Output Shaft Torque |
|---|---|---|
| | Gear Ratio | (N-m) |
| Free Power Turbine | | 57.3 |
| First Reducing Gear Set | 6.78:1 | 385 |
| Planetary or Parallel Gear Set | 4.7:1 | 1,781 |
| Transmission 1st Gear | 4.7:1 | 8,200 |
| Differential | 4.33:1 | 35,155 |
| Vehicle Speed (40-in dia tires) | | 11 mph |

FIG. 2 is a schematic of a second configuration of a hybrid drive train. FIG. 2 shows a free power turbine 1 which is driven by gas flowing in via gas path 21 and expanding to drive the turbine and then flowing out. Free power turbine 1 has a shaft output 31 that rotates in the range of about 50,000 to about 100,000 rpms for a gas turbine engine that outputs about 370 kW of power. The output rpms of free power turbine 1 are reduced by gearbox 2 by a gear ratio of about 6.75:1. The output of gearbox 2, via shaft 32, then drives one-way clutch 3 which is locked when positive torque is being applied to the drive train by free power turbine 1. Output shaft 33 then goes through generator/motor 4 which is free-wheeling unless excitation is applied to the generator/motor 4. Electrical energy generation or extraction by generator/motor 4 is via electrical path 22. In this configuration, the output shaft 34 from generator/motor 4 then goes to a planetary (or parallel) gear set 5 which further reduces the rpms by a gear ratio of about 5:1. The output shaft 35 of gear set 5 then goes via shaft 35 to automatic transmission 6. Transmission 6 typically includes a torque converter and has gearing in the range of about 0.6:1 (highest gear) to about 6:1 (lowest gear) and a torque converter with a further gear reduction ratio of 2.34:1 at high torque and 1:1 when locked up at low torque. Automatic transmission 6 powers drive shaft 7 which is attached to one or more differentials 8. The differentials typically reduce drive shaft 7 rpms by a ratio of about 4:1.

An example of a suitable automatic transmission for the present disclosure is an Allison Model 4500 HS automatic transmission. An example of a suitable generator/motor for the present disclosure is a Remy HVH250 motor made by Remy Electric Motors.

The following tables illustrate an example of the reduction of rpms through the drive train of FIG. 2 with an automatic transmission with torque converter. The free power turbine is suitable for about a 300 to 450 kW power output gas turbine engine and has an output shaft rpm in the range of about 50,000 to about 100,000.

TABLE V

| | Gear Ratio | Output Shaft rpms |
|---|---|---|
| Free Power Turbine | | 60,000 |
| First Reducing Gear Set | 6.78:1 | 8,850 |
| Planetary or Parallel Gear Set | 4.7:1 | 1,883 |
| Transmission 6th Gear with | 0.67:1 | 2,810 |
| Torque Converter Locked-Up | | |
| Differential | 4.33:1 | 650 |
| Vehicle Speed (40-in dia tires) | | 77 mph |

TABLE VI

| | Gear Ratio | Output Shaft rpms |
|---|---|---|
| Free Power Turbine | | 60,000 |
| First Reducing Gear Set | 6.78:1 | 8,850 |
| Planetary or Parallel Gear Set | 4.7:1 | 1,883 |
| Transmission 1st Gear with | 7.5:1 | 250 |
| Torque Converter at 1.6:1 | | |
| Differential | 4.33:1 | 58 |
| Vehicle Speed (40-in dia tires) | | 7 mph |

The following tables illustrate an example of the increase of torque through the drive train of FIG. 2. The free power turbine is suitable for about a 300 to 450 kW power output gas turbine engine and has an output shaft rpm in the range of about 50,000 to about 100,000. The free power turbine outputs in the following example are 200 kW and 60,000 rpms in 6^{th} gear and 360 kW at 60,000 rpms in 1^{st} gear.

TABLE VII

| | | Output Shaft Torque |
|---|---|---|
| | Gear Ratio | (N-m) |
| Free Power Turbine | | 31.8 |
| First Reducing Gear Set | 6.78:1 | 214 |
| Planetary or Parallel Gear Set | 4.7:1 | 990 |
| Transmission 6th Gear with | 0.67:1 | 650 |
| Torque Converter Locked-Up | | |
| Differential | 4.33:1 | 2,784 |
| Vehicle Speed (40-in dia tires) | | 77 mph |

TABLE VIII

| | | Output Shaft Torque |
|---|---|---|
| | Gear Ratio | (N-m) |
| Free Power Turbine | | 57.3 |
| First Reducing Gear Set | 6.78:1 | 385 |
| Planetary or Parallel Gear Set | 4.7:1 | 1,781 |
| Transmission 1st Gear with | 4.7:1 | 12,427 |
| Torque Converter at 1.6:1 | | |
| Differential | 4.33:1 | 53,270 |
| Vehicle Speed (40-in dia tires) | | 7 mph |

As can be seen, the torque converter in automatic transmission 6 is locked up at high speed in 6^{th} gear. The torque converter in automatic transmission 6 adds an additional gear reduction of 1.6:1 at high torque and low speed although there are significant power losses as the efficiency drops from about 98% when locked up in 6^{th} gear to about 93% in 1^{st} gear.

FIG. 3 shows several types of prior art one-way clutch mechanisms. FIG. 3a shows the one-way actions of a sprag clutch mechanism (on the left of FIG. 3a) and a roller ramp clutch mechanism (on the right of FIG. 3a). FIG. 3b shows the one-way action of a mechanical diode type of clutch mechanism. The mechanical diode has the advantage of low-mass and a high ratio of contact area to mass which allows a relatively small spring to very rapidly move the struts into locking position. Mechanical diodes are made, for example, by Epilogics, Inc. of Los Gatos, Calif. FIG. 3c shows the one-way action of a ratchet type of clutch mechanism (taken from FIG. 1 of U.S. Pat. No. 5,954,174). A ratchet type one-way clutch is used for example on the turbocharger of EMD locomotives.

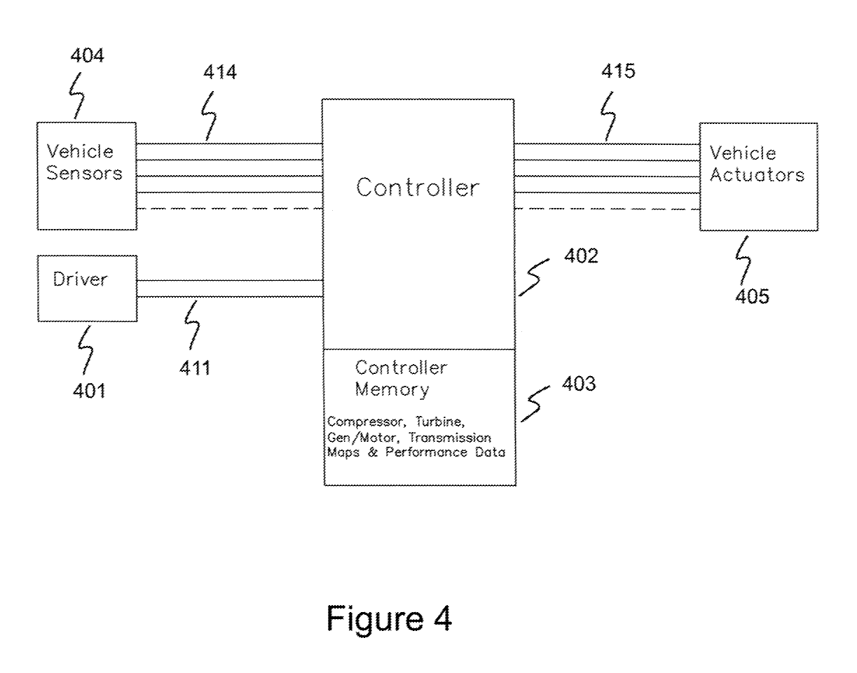

FIG. 4 is a schematic of a simplified controller input/output diagram. This figure shows a computer comprised of a controller 402 and a memory module 403, such as a computer readable medium. The controller 402, which can be microprocessor readable and executable instructions stored in the computer readable medium, receives various inputs 414 from vehicle sensors 404 and from the vehicle's operator or driver 401. These latter inputs 411 are accelerator and brake pedal inputs. The controller 402 using the sensor inputs 414, driver inputs 411 and the vehicle components performance characteristics from the controller memory 403, computes output instructions 415 to the various vehicle actuators 405.

Vehicle component performance characteristics from the controller memory 403 include, for example, the gas turbine engine's compressor and turbine maps especially rpms versus power, the engines output torque versus speed characteristics; the various gear ratios in the drive train; and the generator/motor's excitation and electrical input/output characteristics.

Various vehicle sensors 404 include, for example, vehicle ground speed, wheel rpms, free power turbine output shaft rpms, ambient air conditions, battery pack state-of-charge, thermal energy storage device temperature, rate of fuel consumption and the like.

Various vehicle actuators 405 include, for example, free power turbine variable area nozzle control, engine fuel injection control, electrical control for battery packs, electrical control for generator/motor excitation levels, and transmission gear select controls.

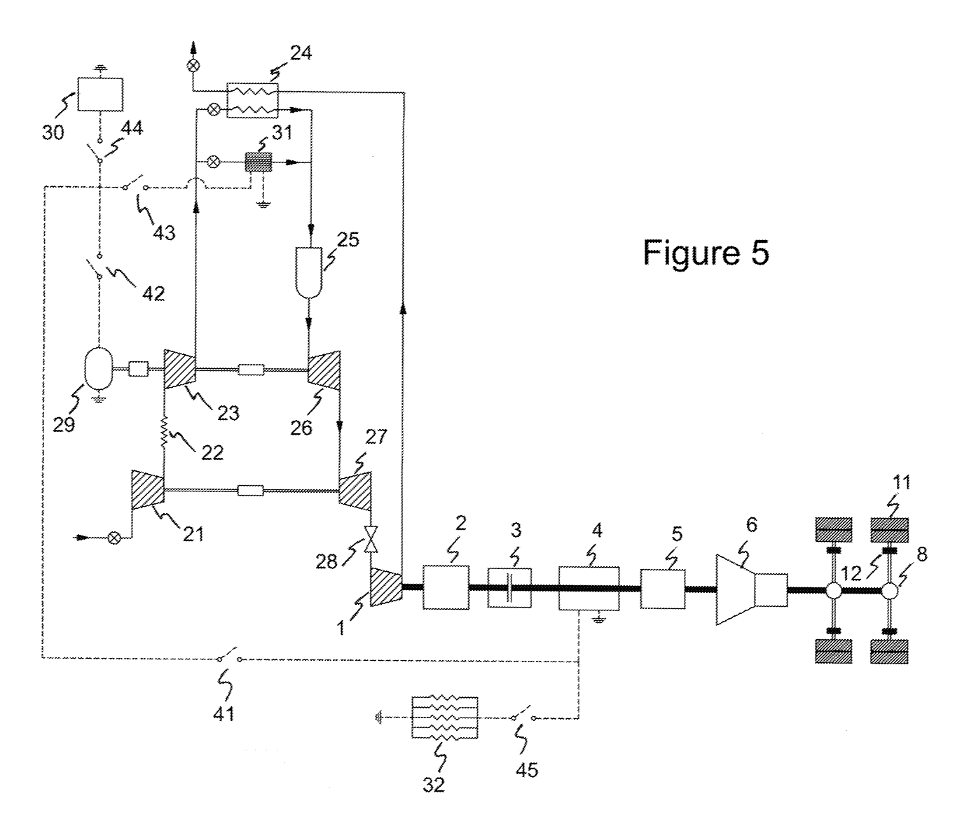

FIG. 5 is an example of a braking system based on the drive train of FIG. 1 or 2. This figure illustrates how the drive train of FIG. 1 or 2 can be adapted to a multi-spool gas turbine engine. The system includes a dynamic braking capability and, if required, a regenerative braking capability. The transmission shown in FIG. 5 is the same as that described in FIG. 2 in which an automatic transmission is shown. As can be appreciated, the manual clutch and transmission shown in FIG. 1 can also be used.

The drive train shown in FIG. 5 is comprised of a reducing gear set 2, a one-way clutch 3, a generator/motor 4, a reducing planetary or parallel gear 5, an automatic transmission 6 and differentials 8, all of which form the drive train for wheels 11. The foundation braking system 12 is also shown.

An intercooled, recuperated gas turbine engine is shown in FIG. 5 and is comprised of low pressure compressor 21, intercooler 22, high pressure compressor 23, recuperator 24, combustor 25, high pressure turbine 26, low pressure turbine 27, variable area nozzle 28 and free power turbine 1. The output shaft of free power turbine 1 powers the drive train shown in FIG. 5. The gas turbine engine shown in FIG. 5 also includes a starter motor 29, a thermal energy storage device 31, a battery pack 30 and a dynamic braking dissipative grid 32.

In starting mode, switches 42 and 44 are closed and all other switches are left open. This allows battery pack 30 to crank starter motor 29 to start the engine by spinning up the high pressure turbo-compressor spool (compressor 23 and turbine 26). This operation is described fully in U.S. patent application Ser. No. 12/115,134 entitled “Multi-Spool Intercooled Recuperated Gas Turbine”. Other means of starting the gas turbine engine is also described in U.S. patent application Ser. No. 13/175,564, entitled “Improved Multi-Spool Intercooled Recuperated Gas Turbine” which is incorporated herein by reference. Switch 43 may also be closed as part of the engine starting process so that some of the energy from battery pack 30 may be used to energize thermal energy storage device 31 which can provide heat energy to the initial flow through the gas turbine engine. This technique is described more fully in U.S. patent application Ser. No. 12/777,916, entitled “Gas Turbine Energy Storage and Conversion System” which is incorporated herein by reference.

In driving mode, it is sometimes desired to provide a rapid power boost to the vehicle. This can be accomplished with the system of FIG. 5 by closing switches 41 and 44 and leaving all other switches open. Battery pack 30 may then be used to provide motoring power to generator/motor 4 which, in turn, can provide additional torque to the drive train for a rapid power boost.

In braking mode, some or all of the braking energy may be absorbed by generator/motor 4 operated as a generator. Braking energy may be converted to electrical energy by generator/motor 4 and sent to one or more of a dynamic braking dissipative grid 32, a battery pack 30 and a thermal energy storage device 31.

For example, in light braking mode, switches 41 and 43 may be closed and all other switches left open so that braking energy is sent to thermal energy storage device 31 which comprises a Joule heating element within the pressure boundary of the engine as described in U.S. patent application Ser. No. 12/777,916, entitled “Gas Turbine Energy Storage and Conversion System”. Alternately, switches 41 and 44 may be closed and all other switches left open so that braking energy is sent to battery pack 30 to increase its state-of-charge. As can be appreciated, braking energy may be sent to both thermal energy storage device 31 and battery pack 30.

In heavy braking mode, switches 41, 43 and 44 may be closed and all other switches left open so that braking energy is sent to both thermal energy storage device 31 and battery pack 30. When thermal energy storage device 31 and battery pack 30 can receive no further braking energy, switch 45 may be closed and switches 43 and 44 opened so that braking energy is diverted to dynamic braking grid 32 where it may be dissipated in a resistive grid and the resulting heat energy transferred to the ambient air by convection.

For the example of a gas turbine engine in a Class 8 truck, the engine may have a full power rating of about 375 kW. If braking power of, for example, 500 kW is required, it can be provided by the foundation braking system. However, generator/motor 4 operated as a generator may be used to absorb some of the braking energy, thereby saving wear and tear on the foundation braking system. A thermal energy storage device such as described in U.S. patent application Ser. No. 12/777,916, entitled “Gas Turbine Energy Storage and Conversion System” may be capable of absorbing braking energy at a rate of about 250 kW for about 30 seconds. The dynamic braking grid 32 may be capable of dissipating a like amount or even more of the required braking energy. Thus the braking system of FIG. 5 can have a significant beneficial effect on both fuel savings and lifetime of the foundation braking system. With the use of the one-way clutch, these benefits can be realized without applying reverse torque on the free power turbine.

As can be appreciated, the braking system of FIG. 5 may be controlled automatically by an on-board computer. The computer can be programmed to co-ordinate the braking system by controlling the output of generator/motor 4 and by directing braking energy to any or all of the dynamic braking dissipative grid 32, battery pack 30 and thermal energy storage device 31. This automatic control would require input from sensors such as, for example, state-of-charge of battery pack 30, temperature of thermal energy storage device 31 and temperature of dynamic braking dissipative grid 32.

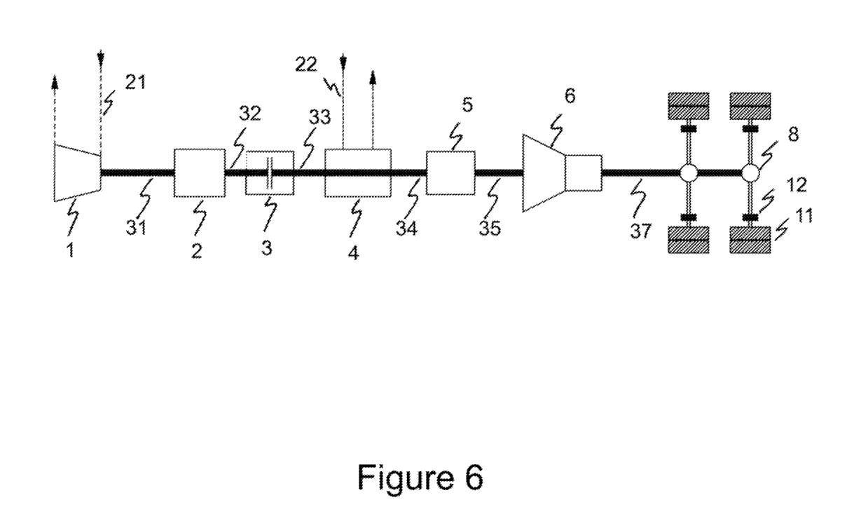

FIG. 6 is a schematic of a third configuration of a hybrid drive train. In this configuration, there is no dry clutch between the planetary (or parallel) gear set and manual transmission. Engaging or disengaging the transmission is done by utilizing a generator/motor to either neutralize torque for disengaging or to synchronize rotary speeds for engaging, as will be described below.

FIG. 6 shows a free power turbine 1 which is driven by gas flowing in via gas path 21 and expanding to drive the turbine and then flowing out. Free power turbine 1 has a shaft output 31 that rotates in the range of about 50,000 to about 100,000 rpms for a gas turbine engine that outputs about 370 kW of power. The output rpms of free power turbine 1 are reduced by gearbox 2 by a gear ratio of about 6.75:1. The output of gearbox 2, via shaft 32, then drives one-way clutch 3 which is locked when positive torque is being applied to the drive train by free power turbine 1. Output shaft 33 then goes through generator/motor 4 which is free-wheeling unless excitation is applied to the generator/motor 4. Electrical energy generation or extraction by generator/motor 4 is via electrical path 22. In this configuration, the output shaft 34 from generator/motor 4 then goes to a planetary (or parallel) gear set 5 which further reduces the rpms by a gear ratio of about 5:1. The output shaft 35 of gear set 5 then goes directly to manual transmission 6 via shaft 35. Transmission 6 typically has gearing in the range of about 0.65:1 (highest gear) to about 5:1 (lowest gear). Transmission 6 powers drive shaft 7 which is attached to one or more differentials 8. The differentials typically reduce drive shaft 7 rpms by a ratio of about 4:1.

Changing Gears without a Dry Clutch

In the following, a method is disclosed for disengaging and engaging gearing in a manual transmission without the need for a dry clutch. The manual transmission may be a synchromesh or non-synchromesh transmission. If it is a non-synchromesh transmission, then the gears themselves must be disengaged and engaged. If it is a synchromesh transmission, then the gears remain meshed and the synchromesh collar and shaft must be disengaged and engaged. In either case, as used herein, the terminology that the gearing must be disengaged and engaged is used.

The generator/motor 4 in the above configuration must be able to absorb or provide enough power to overcome or neutralize the torque provided by the free power turbine 1. That is, the generator/motor 4 must have a power rating in the range of about 250 to about 400 kW for an engine whose free power turbine outputs up to about 375 kW. The generator/motor 4 must be able to absorb or provide up to about 400 N-m of torque at about 14,000 rpm to either neutralize the maximum torque or maximum rotary speed coming out of gearbox 2.

### Disengagement of Transmission

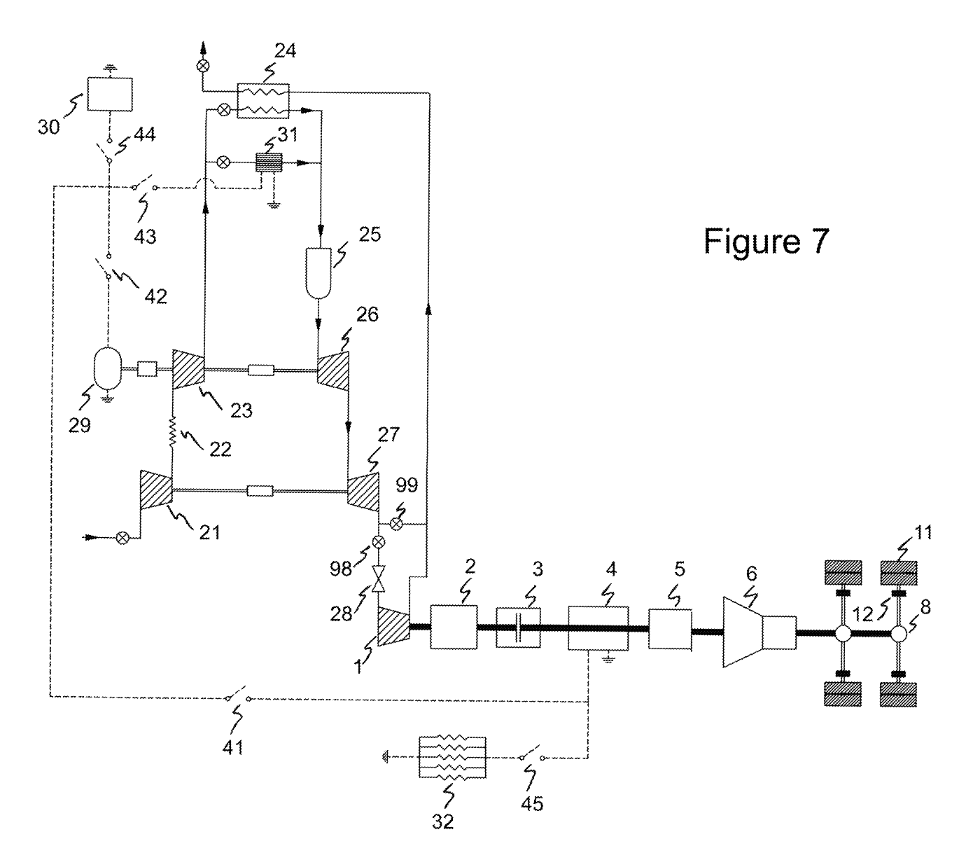

To disengage gears in a transmission, the torque in the drive train must be essentially zero. For example, if the free power turbine is outputting 200 kW of shaft power at 60,000 rpm, the torque coming out of gearbox 2 is about 225 N-m at 9,000 rpm. To neutralize this torque, generator/motor 4 would be operated in generating mode to extract about 200 kW of power which would have to be absorbed by an energy storage system or dissipating resistive grid as described below in FIG. 7. Once the torque from the free power turbine is neutralized, (no significant in torque in the drive train) the gearing in transmission 6 can be disengaged.

### Engagement of Transmission

If the free power turbine is outputting 200 kW of shaft power at 60,000 rpm, the torque coming out of gearbox 2 is about 225 N-m at 9,000 rpm. Generator/motor 4 would be operated in motoring mode to speed up the rpms or generating mode to slow down the rpms so as to synchronize the rpms of the desired gears in the manual transmission 6. With reference to FIG. 6, for example, if first gear has a gear ratio of 4.7:1, then the gears are synchronized when the rpms of shaft 35 are 4.7 times the rpms of shaft 37.

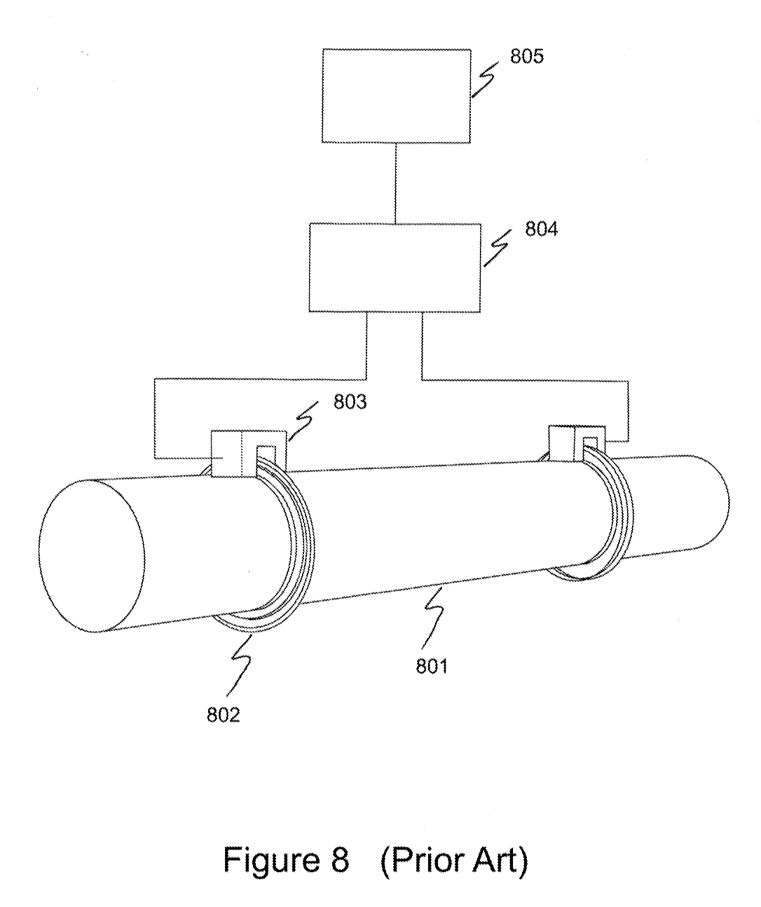

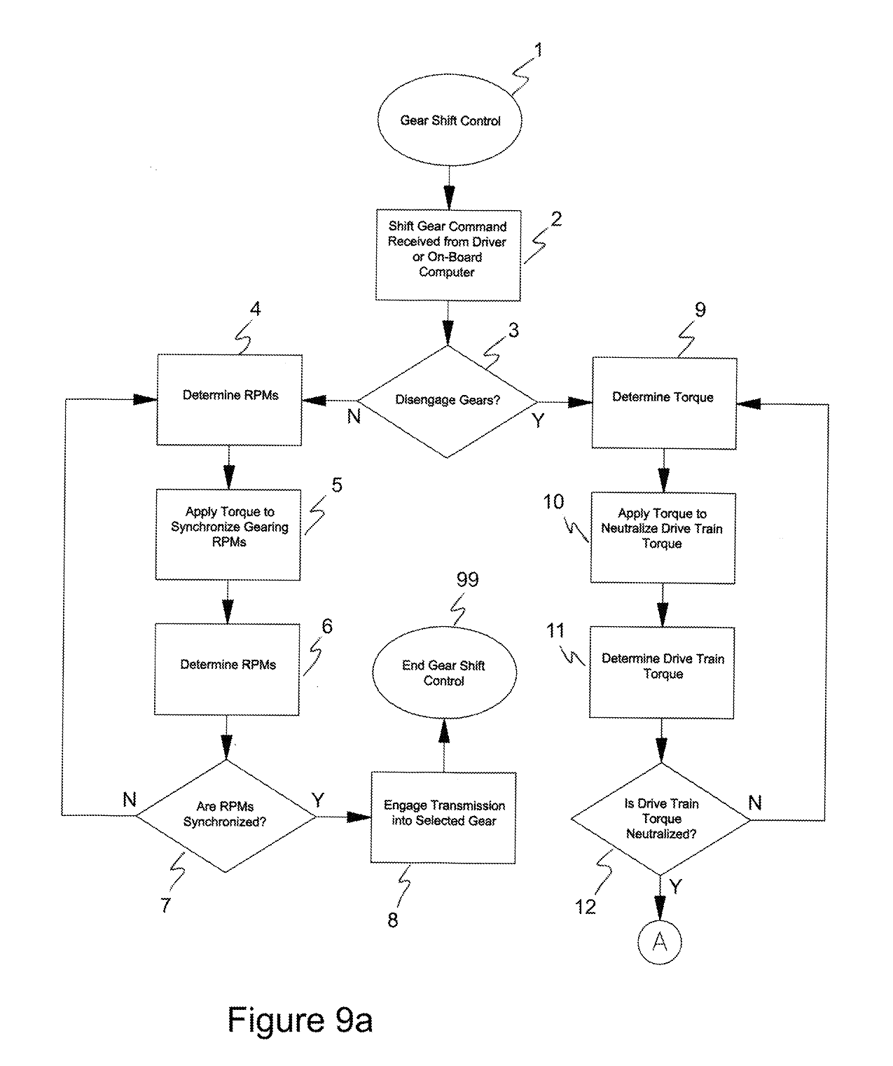

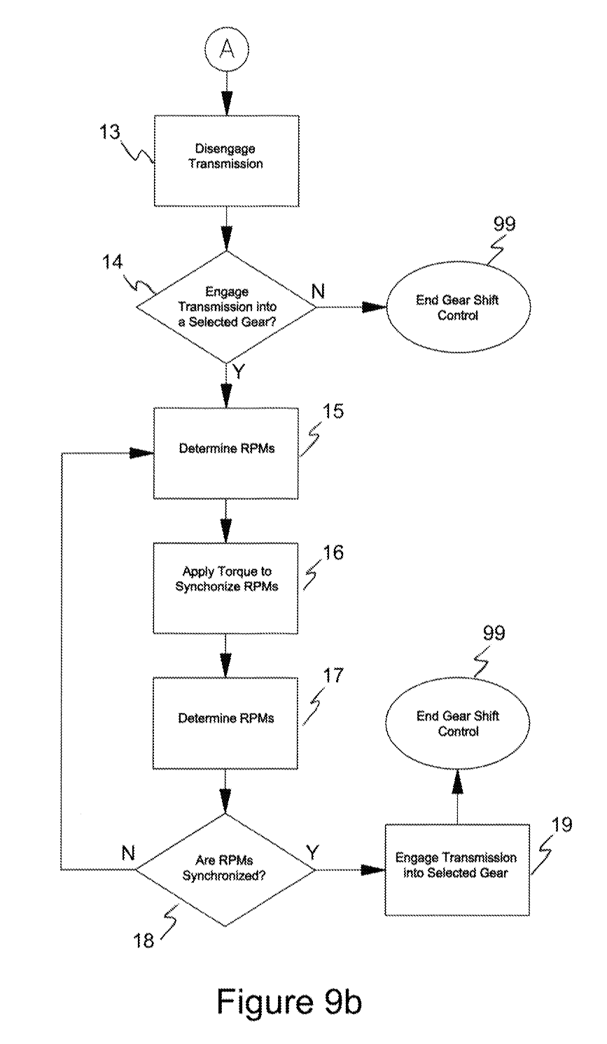

As can be appreciated, the changing of gears whether up-shifting or down-shifting or going from forward to reverse, requires disengaging transmission gearing by neutralizing torque and re-engaging gearing by synchronizing the gearing to be engaged. These operations can be carried out under computer control when the gear ratios, torque and rpms of the transmission input and output shafts are known. One of several well-known methods of making such torque and rpm measurements is described in FIG. 8. The logic flow of changing gears is illustrated in the flow chart of FIG. 9.

FIG. 7 is an example of a braking system based on the drive train of FIG. 6. This figure illustrates how the drive train of FIG. 6 can be adapted to a gas turbine engine. The system includes a dynamic braking capability and, if required, a regenerative braking capability. The drive train shown in FIG. 7 is the same as that described in FIG. 6 where a dry clutch no longer necessary with the manual transmission. The drive train shown in FIG. 7 is comprised of a reducing gear set 2, a one-way clutch 3, a generator/motor 4, a reducing planetary or parallel gear 5, a manual transmission 6 and differentials 8, all of which form the drive train for wheels 11. The foundation braking system 12 is also shown. The gears of the manual transmission 6 are changed as described in FIG. 6 by using generator/motor 4 for disengaging gears by neutralizing torque and re-engaging gears by synchronizing the rotational speeds of the gears to be engaged.

The intercooled, recuperated gas turbine engine shown in FIG. 7 is the same as that of FIG. 5 except for the addition of a wastegate system (valves 98 and 99) on the output of the low pressure turbine 27. The wastegate is a means of modifying the flow of combustion gases through the free power turbine. The wastegate does so by controlling the bypass of combustion gases around the free power turbine 1 to allow the power output of the free power turbine to be reduced beyond that which is possible by reducing fuel consumption and/or by using the variable area nozzle 28 for control. As can be appreciated, the waste gate can be replaced by a gas bleed so that the gas diverted around the free power turbine is exhausted rather than directed back into the gas flow downstream of the free power turbine.

Most modern turbo-charged aircraft use a hydraulic wastegate control with engine oil as a valve control fluid. Inside the wastegate actuator, a spring acts to open the wastegate, and oil pressure acts to close the wastegate. On the oil output side of the wastegate actuator sits the density controller, an air-controlled oil valve which senses upper deck pressure and controls how fast oil can bleed from the wastegate actuator back to the engine. As the aircraft climbs and the air density drops, the density controller slowly closes the valve and traps more oil in the wastegate actuator, closing the wastegate to increase the speed of the turbocharger and maintain rated power. Some systems also use a differential pressure controller which senses the air pressures on either side of the throttle plate and adjusts the wastegate to maintain a set differential. This maintains an optimum balance between a low turbocharger workload and a quick spool-up time, and also prevents surging caused by a bootstrapping effect.

Electric wastegates are less preferred because of the desire to separate engine controls from the electrical system in case of an electrical systems failure.

Starting mode, driving mode and braking mode are the same as described in FIG. 5.

As can be appreciated, the braking system and gear shifting system of FIG. 7 may be controlled automatically by an on-board computer. The computer can be programmed to co-ordinate the braking system by controlling the output of generator/motor 4 and directing braking energy to either or all of the dynamic braking dissipative grid 32, battery pack 30 and thermal energy storage device 31. This would require input from sensors such as state-of-charge of battery pack 30, temperature of thermal energy storage device 31 and temperature of dynamic braking dissipative grid 32. The computer can also be programmed to co-ordinate the gear shifting system by controlling the output of generator/motor 4 along with the fuel consumption and settings for variable area nozzle 28.

In order to accomplish a gear change (disengaging, switching gears and re-engaging), torque and rpms must be monitored. An example of a monitoring system is shown in FIG. 8. As shown in FIG. 8, the rotation of flanges 802 mounted on a rotating shaft 801 is sensed by sensors 803. Data from sensors 803 is acquired by an A/D converter 804 and this digitized data is processed in computer 805 to provide a measurement of torque and rpms. An example of one such system is the Kongsberg Shaft Power Meter, called the MetaPower system. The MetaPower system measures the rpms (revolutions per minute), torque and power transferred from a ships main engine to the propellers. The system uses an infrared laser beam for the detection of the shaft twist, shaft rpms and consequently the transferred power and torque. This system is available from Kongsberg Maritime, P.O.Box 483, NO-3601 Kongsberg, Norway.

Referring to FIG. 6, rpm sensors would be used on shafts 35 and 37 to monitor rpms. A torque sensor or sensor can be used on any shaft in the drive train. These measurements allow the appropriate counter torque to be applied for precision changing of gears.

As can be appreciated, other well-known methods can be used to determine torque and rpms of the various shafts in the drive train.

By monitoring torque and knowing vehicle weight, fuel consumption and fuel low heat value, overall engine thermal efficiency can be directly obtained.

FIG. 9 shows a flow chart for automatically shifting gears using a generator/motor along with a manual transmission. This method eliminates the need for a dry clutch such as clutch 9 in FIG. 1. FIG. 6 illustrates the elements of a hybrid drive train which illustrates a manual transmission 6 whose gearing is shifted using the generator/motor 4. The gear shift control logic illustrated in FIG. 9 is applicable to the hybrid drive train of the present disclosure and can be executed under control of an on-board computer or can be controlled directly by the driver of the vehicle. As described previously, the changing of gears whether up-shifting or down-shifting or going from forward to reverse, requires disengaging gearing by neutralizing torque and re-engaging gearing by synchronizing gear rpms. These operations can be carried out under computer control when the gear ratios, torque and rpms of the transmission input and output shafts are known or by the driver using a gear shift leaver.

Shifting gears using the generator/motor with a manual transmission will be illustrated with reference to the components depicted in FIG. 6.

Gear shift control begins 1 with a gear shift command 2 received by a drive train controller. This command will be to either engage the gearing, disengage the gearing or to disengage and re-engage the gearing (shifting). This command can be given by a computer program that automatically directs gear shifting by appropriate algorithms or by a driver manually selecting a gear shift option which is monitored by the computer program. The first step 3 is to determine whether the transmission is to be engaged or disengaged. This step may be requested whether the vehicle is starting, stopping, reversing or is in motion and whether the vehicle is running on only electrical power, only engine power or both.

If the transmission is to be engaged, the vehicle may be stopped or in motion but its transmission would be in neutral (gears already disengaged). In general, shaft 35 and 37 would be rotating at different rpms so, in step 4, the rpms of shafts 35 and 37 would be determined. In step 5, the generator/motor would be commanded to apply a torque to alter the rpms of shaft 35 until the gears controlled by shafts 35 and 37 are synchronized. In step 6, the rpms of shafts 35 and 37 would again be determined. In step 7, if the rpms do not match those required for synchronization within a selected range, the logic returns to step 4. In step 7, if the rpms match those required for synchronization within a selected range, then, in step 8, the selected gearing is engaged and the gear shift control command is ended (step 99).

If the transmission is to be disengaged, the vehicle may be stopped or in motion but it would be in gear. In general, there would be torque being transmitted through the drive train so, in step 9, the torque on any shaft downstream of the one-way clutch would be determined. In step 10, the generator/motor would be commanded to apply a torque to reduce the torque in the drive train until it is within a selected range of zero. In step 11, the torque on any shaft downstream of the one-way clutch would again be determined. In step 12, if the torque in the drive train is not within a selected range of zero, the logic returns to step 9. In step 12, if the torque in the drive train is within a selected range of zero, then in step 13, the selected gearing is disengaged.

If the gear shift command is only to disengage in step 14, then the gear shift control command is ended (step 99). If the gear shift command is to shift gears in step 14, then the gearing must be engaged with the selected gear. In general, shaft 35 and 37 would be rotating at different rpms so, in step 15 the rpms of shafts 35 and 37 would be determined. In step 16 the generator/motor would be commanded to apply a torque to alter the rpms of shaft 35 until the gears controlled by shafts 35 and 37 are synchronized. In step 17, the rpms of shafts 35 and 37 would again be determined. In step 18, if the rpms do not match those required for synchronization within a selected range, the logic returns to step 15. In step 18, if the rpms match those required for synchronization within a selected range, then, in step 19, the selected gearing is engaged and the gear shift control command is ended (step 99).

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A vehicle, comprising:
a gas turbine engine as a prime power source;
a drive train operatively connected to the gas turbine engine to propel the vehicle, wherein the drive train is free of a dry clutch and comprises:
a one-way clutch to inhibit reverse power flow from the drive train to the engine;
a manual transmission comprising a gear set with a first and second gear having a gear ratio between the first gear and the second gear; and
a generator/motor to at least one of: absorb sufficient power to substantially neutralize torque of the drive train to enable disengaging the transmission from a drive shaft of the drive train; and absorb or supply sufficient power to substantially synchronize the first and second gears in the gear set to enable engaging the transmission with the drive shaft of the drive train.

2. The vehicle of claim 1, wherein the generator/motor is able to absorb or supply up to about 400 N-m of torque at about 14,000 rpm and wherein the generator/motor has a power rating in a range of from about 250 to about 400 kW and the gas turbine engine has a free power turbine outputting up to about 375 kW.

3. The vehicle of claim 1, wherein a controller at least one of: operation (i) disengages the first and second gears when a torque applied by the generator/motor substantially neutralizes the torque in the drive train and operation (ii) engages the first and second gears when a torque applied or absorbed by the generator/motor substantially synchronizes the first and second gears in the gear set in the drive train and wherein the controller comprises microprocessor executable instructions recorded on a tangible, non-transient computer readable medium such that microprocessor execution of the instructions performs the at least one of operations (i) and (ii).

4. The vehicle of claim 1, wherein the one-way clutch is locked when positive torque is applied to the drive train by the gas turbine engine and wherein the one-way clutch comprises a sprag clutch mechanism.

5. The vehicle of claim 1, wherein the one-way clutch is locked when positive torque is applied to the drive train by the gas turbine engine and wherein the one-way clutch comprises a roller clamp clutch mechanism.

6. The vehicle of claim 1, wherein the one-way clutch is locked when positive torque is applied to the drive train by the gas turbine engine and wherein the one-way clutch comprises a mechanical diode clutch mechanism.

7. The vehicle of claim 1, wherein the gas turbine engine comprises a lower pressure compressor coupled to a lower pressure turbine, a higher pressure compressor coupled to a higher pressure turbine, an intercooler positioned in a fluid path between the lower and higher pressure compressors, a recuperator to transfer heat from an exhaust gas to a compressed fluid, a combustor to combust the compressed fluid, and a free power turbine providing power from the gas turbine engine to the drive train.

8. The vehicle of claim 10, wherein the gas turbine engine comprises at least one of (i) a wastegate and (ii) a bleed on an output of the lower pressure turbine, the at least one of a wastegate and bleed modifying a flow of a combustion gas through the free power turbine.

9. A method, comprising:
operating a gas turbine engine as a prime power source to power a drive train operatively connected to the gas turbine engine and thereby propel a vehicle, wherein the drive train is free of a dry clutch and comprises a generator/motor and a manual transmission comprising a gear set with a first and second gear having a gear ratio between the first gear and the second gear;
inhibiting, by a one-way clutch, reverse power flow from the drive train to the gas turbine engine; and
performing at least one of the following sub-steps:
(a) absorbing, by the generator/motor, sufficient power to overcome and/or substantially neutralize torque of the drive train to enable disengaging the transmission from a drive shaft of the drive train; and
(b) absorbing or supplying, by the generator/motor, sufficient power to substantially synchronize the first and second gears in the gear set in the drive train to enable engaging the transmission with the drive shaft of the drive train.

10. The method of claim 9, wherein sub-step (b) is performed and wherein the generator/motor is able to absorb and/or supply up to about 400 N-m of torque at about 14,000 rpm and wherein the generator/motor has a power rating in a range of from about 250 to about 400 kW and the gas turbine engine has a free power turbine outputting up to about 375 kW.

11. The method of claim 9, wherein a controller:
disengages the first and second gears in a gear set when a torque in the drive train is substantially neutralized by the generator/motor; and
engages the first and second gears when a torque in the drive train is applied or absorbed by the generator/motor to substantially synchronize the first and second gears in the gear set in the drive train.

12. The method of claim 9, wherein the one-way clutch is locked when positive torque is applied to the drive train by the gas turbine engine and wherein the one-way clutch comprises a sprag clutch mechanism.

13. The method of claim 9, wherein the one-way clutch is locked when positive torque is applied to the drive train by the gas turbine engine and wherein the one-way clutch comprises a roller clamp clutch mechanism.

14. The method of claim 9, wherein the one-way clutch is locked when positive torque is applied to the drive train by the gas turbine engine and wherein the one-way clutch comprises a mechanical diode clutch mechanism.

15. The method of claim 9, wherein sub-step (a) is performed and wherein the gas turbine engine comprises a lower pressure compressor coupled to a lower pressure turbine, a higher pressure compressor coupled to a higher pressure turbine, an intercooler positioned in a fluid path between the lower and higher pressure compressors, a recuperator to transfer heat from an exhaust gas to a compressed fluid, a combustor to combust the compressed fluid, and a free power turbine providing power from the gas turbine engine to the drive train.

16. The method of claim 9, wherein the gas turbine engine comprises at least one of a wastegate and bleed on an output of the lower pressure turbine, the at least one of a wastegate and bleed modifying a flow of a combustion gas through the free power turbine.

17. A drive train free of a dry clutch, comprising:
a first output shaft operatively engaged with a free power turbine of a gas turbine engine;
a gearbox operatively engaged with the first output shaft;
a second output shaft operatively engaged with a transmission;
a one-way clutch positioned between the gearbox and the second output shaft to inhibit reverse power flow from the second output shaft to the gas turbine engine;
a manual transmission comprising a gear set with a first and second gear having a gear ratio between the first gear and the second gear; and
a generator/motor to at least one of: (i) absorb sufficient power to substantially neutralize torque of the drive train to enable disengaging the transmission from a drive shaft of the drive train and (ii) absorb and/or supply sufficient power to substantially synchronize the first and second gears in the gear set to enable engaging the transmission with the drive shaft of the drive train.

18. The drive train of claim 17, wherein a controller:
disengages the first and second gears in a gear set when a torque in the drive train is substantially neutralized by the generator/motor; and
engages the first and second gears when a torque in the drive train is applied or absorbed by the generator/motor to substantially synchronize the first and second gears in the gear set in the drive train.

19. The drive train of claim 17, wherein the one-way clutch is locked when positive torque is applied to the first output shaft by the gas turbine engine and wherein the one-way clutch comprises a sprag clutch mechanism.

20. The drive train of claim 17, wherein the one-way clutch is locked when positive torque is applied to the first output shaft by the gas turbine engine and wherein the one-way clutch comprises a roller clamp clutch mechanism.

21. The drive train of claim 17, wherein the one-way clutch is locked when positive torque is applied to the first output shaft by the gas turbine engine and wherein the one-way clutch comprises a mechanical diode clutch mechanism.

22. A vehicle, comprising:
a gas turbine engine as a prime power source, wherein the gas turbine engine comprises a lower pressure compressor coupled to a lower pressure turbine, a higher pressure compressor coupled to a higher pressure turbine, an intercooler positioned in a fluid path between the lower and higher pressure compressors, a recuperator to transfer heat from an exhaust gas to a compressed fluid, a combustor to combust the compressed fluid, and a free power turbine providing power from the gas turbine engine to the drive train;
a drive train operatively connected to the gas turbine engine to propel the vehicle, wherein the drive train is free of a dry clutch and comprises a one-way clutch to inhibit reverse power flow from the drive train to the engine;
a transmission; and
a generator/motor to at least one of: (i) absorb sufficient power to substantially neutralize torque of the drive train to enable disengaging the transmission from a drive shaft of the drive train and (ii) absorb or supply sufficient power to substantially synchronize the first and second gears in the gear set to enable engaging the transmission with the drive shaft of the drive train.

23. The vehicle of claim 22, wherein the gas turbine engine comprises at least one of a wastegate and bleed on an output of the lower pressure turbine, the at least one of a wastegate and bleed modifying a flow of a combustion gas through the free power turbine.
